(19) United States
(12) Patent Application Publication
(10) Pub. No.: US 2017/0323542 A1
(43) Pub. Date: Nov. 9, 2017

(54) APPARATUS FOR SECURITY ENHANCEMENT IN CLOSED CIRCUIT TELEVISION USING HARDWARE SECURITY MODULE AND THE METHOD BY USING THE SAME

(71) Applicant: SYSTEM AND APPLICATION TECHNOLOGIES CO., LTD., Gunpo-si (KR)

(72) Inventors: Jong Seog KOH, Daejeon (KR); Jong Min YOON, Seoul (KR); Jun ho LEE, Gunpo-si, Gyeonggi-do (KR)

(21) Appl. No.: 15/590,006

(22) Filed: May 8, 2017

(30) Foreign Application Priority Data
May 9, 2016 (KR) 10-2016-0056396

(51) Int. Cl. G08B 13/196; H04N 7/18; H04N 5/77; H04L 29/06; G11B 31/00; H04N 21/2347; G06F 21/44

(52) U.S. Cl. CPC G08B 13/19656; H04N 21/23476; H04N 7/181; G06F 21/445; H04L 63/068; G11B 31/006; H04N 5/77

(57) ABSTRACT

The present invention relates to an apparatus for security enhancement in closed circuit television (CCTV) using hardware security module and the method by using the same, in which the apparatus is configured to encrypt video data in the process of encoding raw images photographed from IP (Internet Protocol) camera or packetizing the encoded images by using HSM (Hardware Security Moule) embedded in the IP camera, to enable a user to play the encrypted video data after decrypting the encrypted video data by using encryption key which is periodically created and discarded, and not to provide the video data to unauthenticated decvices by constructing secure communication channels among IP camera, user terminal and NVR based on authentication key. Thus, the apparatus prevents the video data from being leaked into network as the video data are non-encrypted and makes it impossible to decrypt the encrypted video data even if the encrypted video data are leaked into network.

### BACKGROUND

The present invention relates to an apparatus for security enhancement in closed circuit television (CCTV) using hardware security module and the method by using the same, in which IP (Internet Protocol) camera acquires video data and encrypts the video data through HSM (Hardware Security Module) and transmits the encrypted video data via network, NVR(Network Video Recorder) records and manages the encrypted video data, a user plays the video data after decrypting the encrypted video data coming from NVR with encryption key kept in (key) managing server, and thus the encrypted video data can be protected from being leaked into network as well as cannot be decrypted due to the above encryption even though the encrypted video data is leaked.

Recently with advancing information technologies, technologies associated with acquiring and transmitting videos have also been getting better, and thus IP camera based a CCTV (Closed Circuit Television) system which encodes video data acquired from a camera, converts the video data to IP packets, transmits the IP packets via wired or wireless network and then records the video packets into a storage media is generally trended.

Though existing CCTV systems have the structures to transmit video data acquired from a camera via copper cables (i.e., BNC cable, etc) and store the video data into DVR (Digital Video Recorder), or transmit, store and manage the video data already stored in DVR to/in a central monitoring server, they are gradually replaced with IP based CCTV systems which have the structures of converting the video data acquiring from IP camera into IP packets at the camera end, and transmitting the video data to NVR via wired and/or wireless networks and storing the video data in storage media.

However, nowadays most of video data transmitted over wired and/or wireless networks are not encrypted and thus they are vulnerable to security. Even technologies utilizing network security protocols are now ever being dissemilated, these kinds of technologies cannot actually escape from hacking. Especially they cannot provide with the same security as the amount that hardware security module is directly applied to IP camera.

Therefore, the present invention provides a CCTV security enhancing technology preventing acquired video data from being disclosed outside CCTV system and making not easy to decrypt the video data, which are even disclosed outside the CCTV system, by encrypting the acquired video data by applying hardware security module to each of IP camera, NVR, managing server and user terminal, which are composed of a CCTV system, and by enabling a user to decrypt and play the encrypted video data with encryption key.

Hereinafter, prior arts existing in the technical area of the present invention are briefly explained and then the technical features that the present invention discriminatorily wishes to accomplish compared to the prior arts technologies are described.

Firstly, Korean patent application KR10-2016-0018282 (2016 Feb. 17) relates to a U-city image processing, monitoring and control system capable of obtaining a security image of a personal IP-CCTV camera, and encoding and transferring the security image by a monitoring and control server, and more specially the system configured to receive security images of personal IP-CCTV camera, which are transmitted to an image providing server of a manufacturing company, with sneeping method, encrypt the images with public key encryption method, modulate and transmit IP address or URL with spoofing method.

The above prior art discloses a U-city security image processing, monitoring and control system locating between personal IP-CCTV camera and an image providing server of a manufacturing company, the system is configured to obtain security image of the personal IP-CCTV with sneeping method, encrypt the image with public encryption method and modulate IP address or URL of image data packets transmitted to the image providing server with spoofing method.

However, the present invention is configured to encrypt video data in the processes of encoding raw image or packetizing the encoded video data by using hardware security module equipped in IP camera, decrypt the encrypted video data through encryption key periodically generated and discarded and prevent the acquired video data from being provided to unauthorized devices by constructing secure communication channels through authentication key. Thus, the technical features of these two inventions are different.

Moreover, Korean patent application KR10-2006-0033768 (2006 Apr. 19) relates to an encoding/decoding device of a camera and a method of controlling the encoding/decoding device. Especially the device provides to encode and to transmit an image photographed by the camera in real time and decode the encoded image in a receiver to maintain security when video data are transmitted.

Even the concept of the prior art is similar to that of the present invention in that the photographed image is encrypted and decrypted, especially a camera transmits the encrypted video data after encrypting the video data in real-time and the encrypted video data are decrypted in the receiving part, the present invention is configured to encrypt the video data in the processes of encoding raw images or packetizing the encoded video data by using hardware security module equipped in IP camera, decrypt the encrypted video data through encryption key periodically created and discarded, and prevent the acquired video data from being provided to unauthorized devices by constructing secure communication channels through authentication key. Thus, the technical features of these two inventions are different.

In addition, Korean patent registration NO. KR10-1320350 (2013 Oct. 23) relates to a secure management server and video data managing method of the secure management server, especially to a security control server capable of allowing reading of image data according to the access level of a user and s method for managing image data of the security control server.

This prior art technology is characterized in that video data is stored according to the access level when the video data is stored of a user and the user who wishes to monitor the video data is capable of monitoring the video data only if the accessible right is allowed after successful user authentication. On contrary, the present invention is configured to encrypt the video data in the processes of encoding raw image or packetizing the encoded video data by using hardware security module equipped in IP camera, decrypt the encrypted video data through the encryption key periodically generated and discarded and prevent the acquired video data from being provided to unauthorized devices by constructing secure communication channels through authentication key. Thus, the technical features of these two inventions are different.

As a result, even though the prior arts technologies apply encryption and decryption of the photographed video data to their technologies, the present invention is not limited to the encryption and decryption of video data as disclosed in the prior arts, and provides the technologies encrypting video data in the processes of encoding raw image or packetizing the encoded video data by using hardware security module equipped in IP camera, managing encryption key through the periodic generation and discard of the encryption key, and preventing the acquired video data from being provided to unauthorized devices by constructing secure communication channels through authentication key among IP camera, managing server and user terminal.

### SUMMARY

The present invention is composed for resolving the above problems, and it is objective to provide an apparatus for security enhancement in closed circuit television using hardware security module and the method by using the same, in which IP camera equipped with hardware security module encrypts the photographed video data and transmits the encrypted video data via network, NVR stores and manages the encrypted video data, and finally a user can play the photographed video data after decrypting the encrypted video data with the encryption key provided from managing server.

Moreover, it is objective to provide an apparatus for security enhancement in closed circuit television using hardware security module and the method by using the same, in which the hardware security module encrypts the photographed video data in the processes of compressing (or encoding) raw image of the video data photographed in IP camera according to predetermined units of encoding levels (for example, a block, a macroblock, a slice, a field, a frame, a picture, I-frame, GOP (Group Of Pictures), sequence, etc.) or in the process of packetizing the encoded video data after compressing (encoding) the photographed video data.

In addition, it is objective to provide an apparatus for security enhancement in closed circuit television using hardware security module and the method by using the same, in which managing server periodically creates and discards encryption key used in hardware security module and thus managing the encryption key and enforcing security.

In addition, it is objective to provide an apparatus for security enhancement in closed circuit television using hardware security module and the method by using the same, which prevents the photographed video data from being leaked to unauthorized devices by constructing secure communication channels through the authentication key among IP camera, managing server and user terminal.

In addition, it is objective to provide an apparatus for security enhancement in closed circuit television using hardware security module and the method by using the same, which encrypts audio and sensing data associated with surrounding environment of IP camera, along with raw video data, when encrypting the photographed video data using hardware security module in IP camera.

An apparatus of enhancing security of CCTV by using hardware security module in accordance with an embodiment of the present invention comprises hardware security module configured to produce encrypted video data after encrypting input video data by using encryption key based on hardware, and processor configured to encode video data acquired from camera and packetize the encoded video data.

Wherein the encryption is configured to be performed in the process of encoding the input video data acquired from camera, packetizing the encoded video data, or both encoding the input video data and packetizing the encoded video data, and the processor is configured to encode or packetize the encrypted video data by making the hardware security module encrypt the video data generated in the process of the encoding, packetizing or the combinations thereof.

The hardware security module, further comprises a secure memory including SD (Secure Digital) memory card storing the encryption key.

Moreover, the apparatus of enhancing security of CCTV is further configured to provide the encrypted video data to NVR or user terminal, and the NVR or the user terminal play the encrypted video data through the hardware security module.

In addition, the processor is further configured to control recording the information indicating which part of the video data is encrypted, to header of the encrypted video data or a specific individual file as a metadata.

In addition, the processor is configured to control to encrypt the photographed video data using the encryption key in the process of compressing or encoding the video data with predetermined units of encoding levels (i.e., a block, a macroblock, a slice, a field, a frame, a picture, I-frame, GOP (Group Of Pictures), sequence, etc.) or in the process of packetizing the encoded or compressed video data, or in the processes of both compressing or encoding the photographed video data with predetermined units and packetizing the encoded or compressed video data.

Moreover, the encryption key stored in the hardware security module is periodically generated and discarded through the control of managing server at predetermined interval of time. And the authentication key for securing communication channels is additionally generated through the managing server and provided to camera, user terminal and NVR, and the encrypted video data is transmitted and received after encrypting the communication channel using the authentication key.

In addition, the processor is configured to control encrypting audio data and sensing data measured in sensors equipped in camera, along with the video data acquired from the camera, with the encryption key.

In addition, a method of enhancing security of CCTV by using hardware security module in accordance with another embodiment of the present invention comprises producing encrypted video data after encrypting input video data based on hardware by using an encryption key in the hardware security module, and encoding input video data acquired from a camera and packetizing the encoded video data in processor.

Wherein the encryption is configured to be performed in the process of encoding the input video data acquired from camera, packetizing the encoded video data, or both encoding the input video data and packetizing the encoded video data, and the processor is configured to encode or packetize the encrypted video data by making the hardware security module encrypt the video data generated in the process of the encoding, packetizing or the combinations thereof.

In addition, the method further comprises playing the recorded video data after decrypting the encrypted video data through the encryption key in user terminal. And the encryption key stored in the hardware security module is periodically generated and discarded through the control of managing server at predetermined interval of time.

In addition, the method further comprises generating additionally authentication key for securing communication channels through managing server, providing the authentication key to camera, user terminal and NVR, and authenticating the communication channels through the authentication key. And the processor is configured to control encrypting audio data and sensing data measured in sensors equipped in camera, along with the video data acquired from the camera, with the encryption key.

As described above, in accordance with an apparatus for security enhancement in closed circuit television using hardware security module and the method by using the same, the present invention takes advantages of transmitting encrypted video data which are photographed in IP camera and encrypted through the hardware security module, storing and managing the encrypted video data in NVR, finally decrypting and playing by a user the photographed video data based on the encryption key provided from managing server, and thus not being easy to decrypt the photographed video data due to the encryption even if the photographed video data are leaked.

In addition, the present invention takes advantages of being easy to confirm which point of encrypted video data is encrypted and thus easy to manage photographed video data, since the encryption is performed by using hardware security module in the processes of encoding or compressing the raw image of the video data photographed from IP camera with predetermined units or in the process of packetizing the encoded or compressed video data.

In addition, the present invention takes advantages of enhancing security key management and security since the managing server periodically generates and discards encryption key used in hardware security module.

In addition, the present invention takes advantages of preventing video data from being leaked to unauthorized devices since communication channels among IP camera, managing server, and user terminal are securely constructed with authentication key.

Moreover, the present invention takes advantages of easily managing encryption associated with CCTV operations, because audio data and sensing data associated with surrounding environment of IP camera along with raw images can be transmitted to managing server while encrypting the data by using hardware security module of IP camera.

### BRIEF DESCRIPTION OF THE DRAWINGS

For more complete understanding of this disclosure, reference is now made to the following brief description, taken in connection with the accompanying drawings and detailed description.

FIG. 1 is a conceptual diagram for explaining an apparatus and method for CCTV security enhancement by using hardware security module in accordance with the present invention.

FIG. 2 shows a drawing briefly depicting the structure of an apparatus for CCTV security enhancement using hardware security module in accordance with an embodiment of the present invention.

FIG. 3 shows a drawing depicting in detail the structure of IP camera in an apparatus for CCTV security enhancement using hardware security module in accordance with an embodiment of the present invention.

FIG. 4 shows a drawing depicting in detail the structure of managing server in an apparatus for CCTV security enhancement using hardware security module in accordance with an embodiment of the present invention.

FIG. 5 shows a flowchart depicting in detail the operational processes of a method for CCTV security enhancement using hardware security module in accordance with another embodiment of the present invention.

### DETAILED DESCRIPTION

Hereinafter, the preferred embodiments of the present invention, an apparatus for security enhancement in closed circuit television using hardware security module and a method by using the same, are explained in detail by referring to the attached figures. The present invention can be implemented with various different types of devices and methods; thus, it is not limited to the only preferred embodiments explained in this specification. The same reference numbers described in the figures denote the same means and steps.

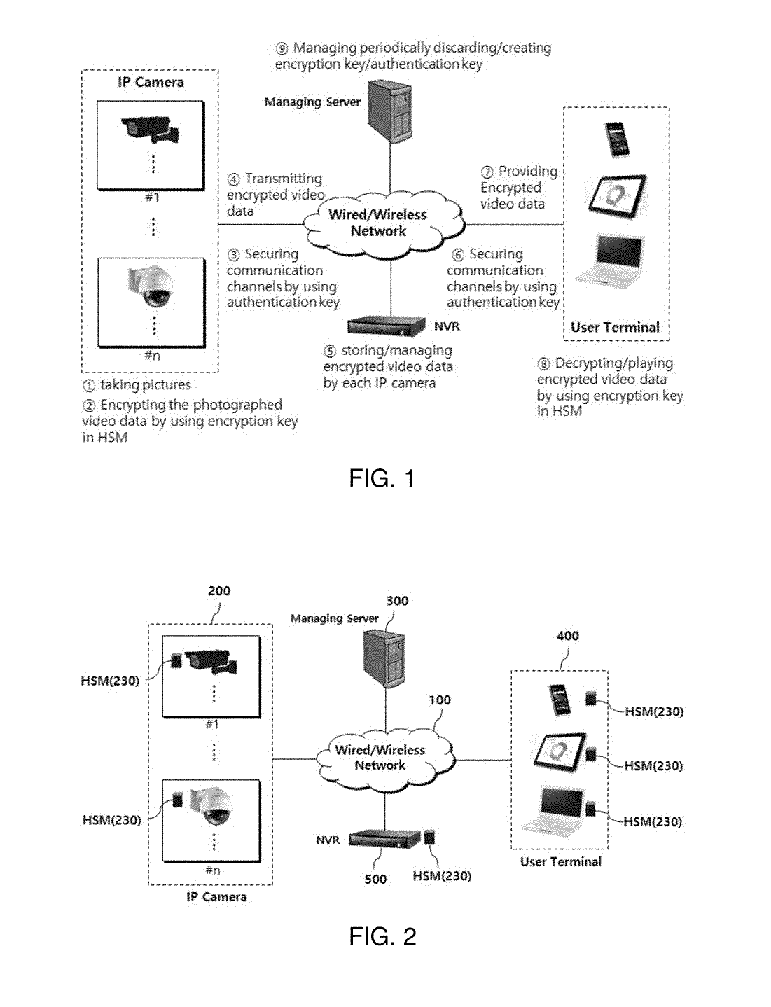

FIG. 1 is a conceptual diagram for explaining an apparatus and a method for CCTV security enhancement by using hardware security module in accordance with the present invention. Wherein, the sequences performing the method in accordance with the present invention can be changed by environments using the apparatus or a person skilled in the arts.

As shown in FIG. 1, IP camera takes moving pictures for the surrounding building, street, etc. at which the IP camera is installed and security, crime prevention or the combinations thereof are needed (\textcircled{1}).

After IP camera takes moving pictures, the IP camera encrypts the moving pictures based on encryption key stored in hardware security module (HSM) which is electrically connected to the IP camera (\textcircled{2}). For example, the IP camera encrypts raw images photographed video data by using the encryption key stored in the hardware security module in the processes of video compression with predetermined units of encoding levels (i.e., block, macroblock, slice, field, frame (or picture), GOP (Group of Pictures), sequence or the combinations thereof), or in the processes of packetizing the video data after compressing the raw images with predetermined units of encoding levies. Moreover, the IP camera can also perform encryption in all the processes mentioned above.

After encrypting with the encryption key, the IP camera performs safety confirmation for communication channels based on authentication key stored in NVR and the hardware security module (\textcircled{3}). That is, it can be protected to leak video data to unauthorized devices by performing authentication between IP camera and NVR using the authentication key before transmitting and receiving the encrypted video data.

After authenticating communication channels, the IP camera transmits the encrypted video data to NVR (\textcircled{4}). At this time, according to the service environment of a CCTV system, IP camera can also provide the encrypted video data to user terminal administrated by a security manager.

Then, NVR confirms the encrypted video data transmitted from IP camera, and stores and manages the encrypted video data by each IP camera (200) (\textcircled{5}).

And after confirming safety of communication channels between user terminal and NVR (\textcircled{6}), NVR transmits the encrypted video data photographed from a specific IP camera which are stored and managed in NVR to user terminal (\textcircled{7}).

User terminal receiving the encrypted video data from NVR plays video data after decrypting the encrypted video data by using the encryption key stored in hardware security module which is electrically connected to user terminal (\textcircled{8}). At this time, in case that the encryption key is not the same as that used at the time of encrypting the video data photographed in IP camera, the user terminal can not decrypt the encrypted video data provided from NVR.

Moreover, managing server prevents the video data from being leaked by external hacking by managing of periodically discarding and generating encryption key and authentication key stored in hardware security module equipped with each IP camera and each user terminal (\textcircled{9}). At this time, the managing server can only periodically manage encryption key, and may not manage authentication key according to environments utilizing IP camera. That is, the process \textcircled{3} performing safety confirmation for communication channels through authentication key in IP camera and the process \textcircled{6} confirming safety of communication channels between user terminal and NVR can be omitted according to the environments utilizing NVR.

FIG. 2 shows a drawing briefly depicting the structure of an apparatus for CCTV security enhancement using hardware security module in accordance with an embodiment of the present invention.

As shown in FIG. 2, an apparatus in accordance with the present invention, comprises wired/wireless network (100), IP camera (200), managing server (300) and user terminal (400).

The wires/wireless network (100) can be various kinds of communication networks currently disclosed as wired/wireless internet, Bluetooth, Zigbee, Wifi, etc., interconnects IP camera (200), managing server (300) and user terminal (400) with communication links, and the data communications with respect to encrypted video data can be mutually made up of among them.

At least more than one of IP camera (200) is installed at a building, street, etc. at which security, crime prevention, etc. are needed, and transmits the photographed video data to NVR (500) or user terminal (400) with minimizing delay occurred when transmitting and receiving images with applying high performance specifications (for example, supporting 3 Mpixel 30 fps). Since IP camera (200) electrically connects to hardware security module storing encryption key and transmits the photographed video data encrypted with the encryption key stored in the hardware security module to NVR (500) or user terminal (400), the unencrypted video data are prevented from being leaked, and the encrypted video data cannot be restored without the encryption key even if the encrypted video data is leaked.

When IP camera (200) encrypts the photographed video data, it is desirable for the IP camera (200) encrypts raw images of photographed video data by using the encryption key stored in the hardware security module in the processes of compressing the raw images of the photographed video data with predetermined units of encoding levels. The IP camera can also encrypt the compressed images by using the encryption key stored in the hardware security module in the process of packetizing the compressed images after compressing the raw images with predetermined units.

More specifically, IP camera can take pictures by using camera module and flexibly control security enhancement levels for the video data by selectively encrypting specific codes at blocks or macroblocks levels, or slice headers, field or frame headers, GOP headers, sequence headers, or the combinations thereof when encoding (MPEG4, H.264. HEVC, etc.) the photographed video data.

Wherein, IP camera (200) can encrypt raw images of photographed video data in both processes of compressing raw images with the predetermined units of encoding or compressing levels and packetizing the encoded video data after compressing the raw images with the predetermined units, by using the encryption key stored in the hardware security module, and the IP camera can also encrypt the photographed video data at any step of being capable of encrypting the photographed video data even beside the above described two processes.

Managing server (300) is a computer being administrated by a business operator providing CCTV security services, manages encryption keys stored in hardware security module equipped with IP camera by periodically discarding and newly generating encryption keys, and then prevents the encryption keys from being leaked to others.

Moreover, managing server (300) manages encryption keys stored in hardware security module electrically connected to IP camera through the communication with IP camera, and NVR (500) stores and manages the encrypted video data after encrypting the photographed video data taken from each IP camera in accordance with the encryption key authenticated by the managing server (300). Due to the above processes, security can be enhanced because encrypted video data can not be decrypted if encryption key is unknown even if encrypted video data are leaked out in the process of transmitting encrypted video data.

Moreover, managing server (300) additionally creates authentication key for securing communication channels and transmits the created authentication key to IP camera (200) and user terminal (300) and then stores them in their hardware security modules. At this time, authentication key is used for securing communication channels before transferring and receiving the encrypted video data among IP camera (200), managing server (300) and user terminal (400), and thereby it is for preventing the photographed video data from being provided to unauthorized devices by performing authentication with authentication key between both sides of communications before encrypted video data are transmitted and/or received between both sides of communications.

Of course, managing server (300) also manages authentication key with the same method as that for encryption key by periodically discarding and creating authentication key, and thereby prevents authentication key from being leaked.

User terminal (400) can be a personal computer (PC), a tablet, a notebook PC, a desktop PC, etc., which are handled by security managers in specific buildings and/or areas. The user terminal (400) is electrically connected to hardware security module storing encryption key, and plays encrypted video data by decrypting the encrypted video data with the encryption key transferred from the managing server (300).

Wherein the encryption key can be provided from IP camera (200) not from the managing server (300) according to usage environments, and encrypted video data can be provided from IP camera (200) not from NVR (500) according to usage environments.

For example, as shown in FIG. 1, since both IP camera (200) located in #1 and a specific user terminal monitoring the photographed video data taken from IP camera (200) located in #1 might store the same encryption key, the video data encrypted with a specific encryption key in IP camera (200) located in #1 can play the encrypted video data at the user terminal (400) by decrypting the encrypted video data with the same encryption key as that for the IP camera (200).

NVR (500) stores encrypted video data and their related information received from each IP camera (200) under the controls of NVR (500) itself or managing server (300). That is, NVR (500) receives its encrypted video data from each IP camera (200) through wired/wireless network (100) and manages encrypted video data by storing encrypted video data by each IP camera (200). NVR (500) provides encrypted video data to user terminal (400) owned by a security manager, and encrypted video data can be decrypted with encryption key and played on user terminal (400). Wherein, NVR (500) includes a hardware security module which is electrically connected to an NVR (500) itself. NVR (500) confirms encrypted video data transmitted from each IP camera (200) on the basis of encryption key stored in hardware security module, and stores encrypted video data at a storage device (i.e., database).

In a case that encoded bitstream is encrypted and directly passed through the communication module, the communication module just sends the encrypted encoding bitstream as it is just treated as payload of IP packet. However, the present invention encrypts the encoded bitstream in the process of packetizing the encoded bitstream. Thus, the present invention can insert encryption of the encoded bitstream inside each IP packet. The processor (210) of the present invention interactively communicates with hardware security module and encodes/packetizes the encoded bitstream/IP packet by being returned the encrypted video data/the encoded bitstream from hardware security module in each IP camera.

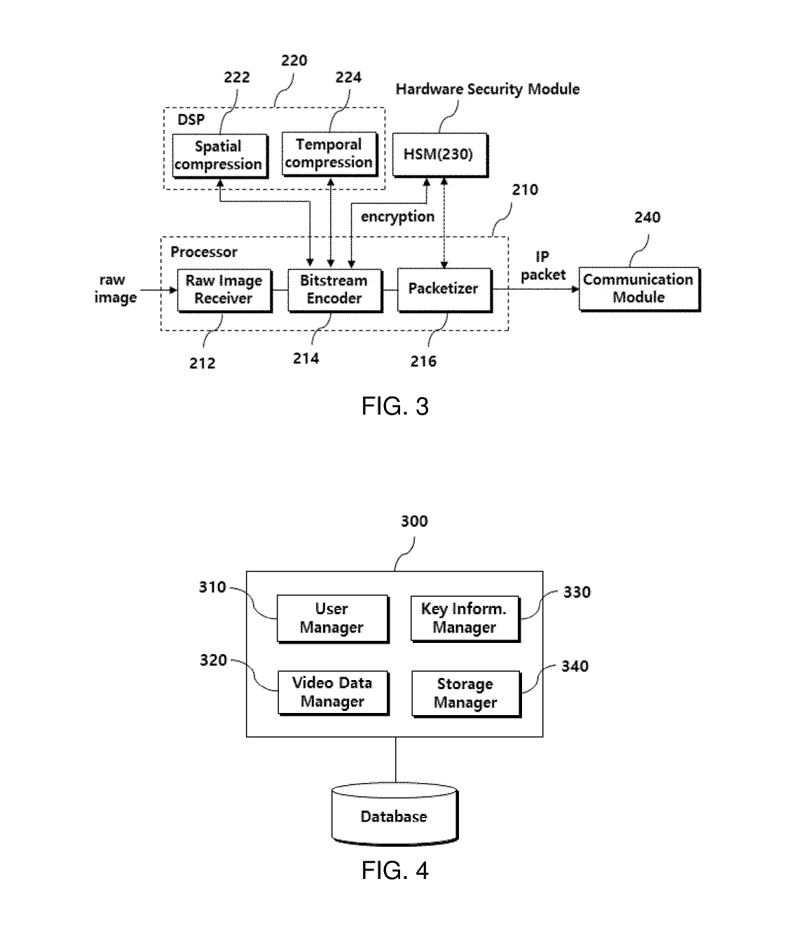

FIG. 3 shows a drawing depicting in detail the structure of IP camera in an apparatus for CCTV security enhancement using a hardware security module in accordance with an embodiment of the present invention.

As shown in FIG. 3, IP camera (200) comprises a processor (210), a DSP (Digital Signal Processor) (220), a hardware security module (230) and a communication module (240).

The processor (210) is configured to perform compressing the raw images of the photographed video data and packetizing the compressed image data, and to control hardware security module (230) to encrypt the raw images of the photographed video data by using encryption key. The processor (210) is also configured to comprise a raw image receiver (212) receiving the raw images of the photographed video data, a bitstream encoder (214) generating video stream after compressing the raw images received from the raw image receiver (212), and a packetizer (216) packetizing the video stream generated at the bitstream encoder (214) after compressing the raw images and producing the packet to a communication interface (240).

Wherein, the processor (210) can be configured to control performing encryption by using encryption key at hardware security module (230) when compressing raw images of the photographed video data with predetermined units of encoding or compressing levels, or performing encryption by using encryption key at hardware security module (230) when packetizing the encoded stream after compressing raw images of the photographed video data with predetermined units of encoding or compressing levels. Otherwise, the processor (210) is configured to control performing encryption of the photographed video data in all the above-mentioned processes.

Moreover, the processor (210) can be configured to contain the information of which parts of the photographed video data are encrypted when encrypting the photographed video data, to header of the encrypted video data. In addition, the processor (210) can be configured to record the information of which parts of the photographed video data are encrypted when encrypting the photographed video data, to an individual file or a metadata beside the header of the encrypted video data.

Herein, security is enhanced if photographed video data are encrypted in block levels, and thus performing encryption in block levels makes the security level set higher. The encryption can be also applied to a macroblock, slice, field or frame basis. In these cases, since at least one encryption is applied to at least every single frame, a user who does not know encryption key cannot decrypt just a single frame.

In addition, IP camera (200) can apply encryption to only I-frame, and thus P-frame or B-frame is never decrypted unless I-frame is not decrypted. Otherwise, it is possible to encrypt GOP basis, video, audio and data sequence basises, or program stream basis.

The present invention records the information related to encryption as a metadata, and the metadata can be used for decrypting encrypted video data.

Moreover, the processor (210) can be configured to control encrypting audio data and detection data measured from sensors equipped with IP camera along with the video data photographed by IP camera, by using encryption key in hardware security module (230).

DSP (220) is configured to compress raw images based on controls of bitstream encoder (214) in processor (210). For example, DSP (220) comprises spatial compression (222) and temporal compression (224). The spatial compression (222) mainly performs the algorithms removing spatial redundancy among adjacent pixels within a single picture (i.e., discrete cosine transform (DCT) algorithm, variable length coding (VLC) algorithm, etc.). The temporal compression (224) performs the algorithms removing temporal redundancy between frames (pictures) (i.e., Motion estimation (ME) algorithm, etc.).

Hardware security module (230) stores encryption key and encrypts the video data photographed from IP camera by using the encryption key according to the encryption request from the processor (210).

Wherein the hardware security module (230) is preferred to be prepared as a SD memory card type.

Moreover, the encryption key stored in hardware security module (230) is discarded and replaced with newly created encryption key at every predetermined cycle through the control of managing server (300). That is, it is highly possible to prevent encryption key from being leaked to others since encryption key is periodically discarded and generated by managing server (300).

The Communication module (240) is configured to provide the video data encrypted by the control of processor (210) to NVR (500) or user terminal (400).

FIG. 4 shows a drawing depicting in detail the structure of a managing server in an apparatus for CCTV security enhancement using hardware security module in accordance with an embodiment of the present invention.

As shown in FIG. 4, managing server (300) comprises a user manager (310), a video data manager (320), a key information manager (330) and a storage manager (340).

The user manager (310) is configured to perform managing the information of user terminal (400) browsing encrypted video data and at least more than one of IP cameras (200) installed at the buildings designated by a business operator using a CCTV system. For example, the information can be MAC address of IP camera (200) and user terminal (400).

The video data manager (320) is configured to store video data encrypted at each IP camera (200) to NVR (500). Wherein the encrypted video data are managed for each individual IP camera and user.

The key information manager (330) is configured to perform periodically discarding and creating encryption key stored in a hardware security module equipped in each IP camera (200) and user terminal (400).

In addition, beside key information manager (330) is configured to manage encryption key used for encrypting and decrypting the photographed video data, the key information manager (330) is configured to manage authentication key with the same method as that for encryption. The authentication key is used for ensuring safety of communication channels before transmitting and receiving encrypted video data mutually among IP camera (200), managing server (300) and user terminal (400).

The storage manager (340) is configured to store the information to database. The information includes the information related to each IP camera and user terminal processed in user manager (310), the information related to each IP camera and individual user processed in the video data manager (320), and the information related to periodically discarding and creating encryption key or authentication key processed in key information manager (330).

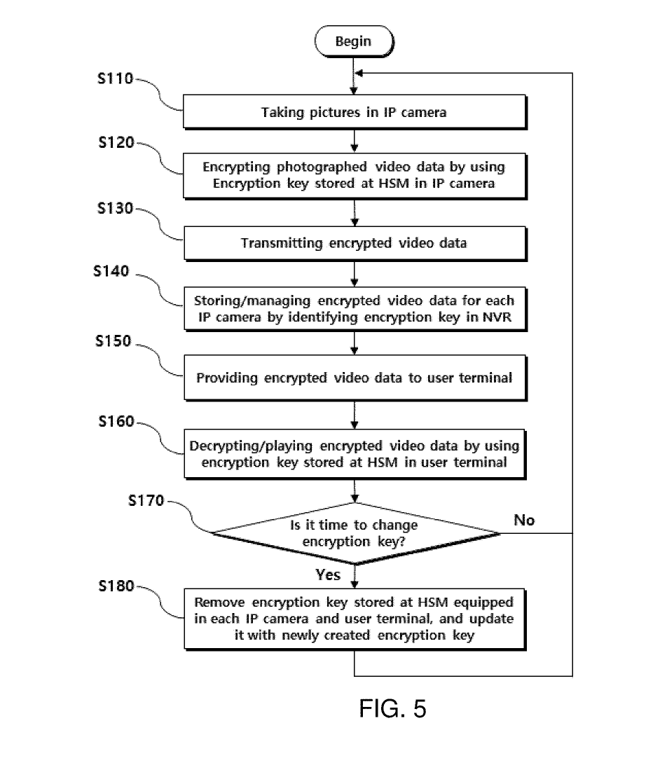

Hereinafter, a preferred embodiment of a method for CCTV security enhancement using a hardware security module in accordance with the present invention is explained in detail with reference to accompanying FIG. 5. Wherein the order of sequences in accordance with the method of the present invention can be changed by usage environments and a person skilled in the art.

FIG. 5 shows a flowchart depicting, in detail, operational processes of a method for CCTV security enhancement using a hardware security module in accordance with another embodiment of the present invention.

Firstly, IP camera (200) installed at buildings, street, and etc. asking for security and anticrime patrol takes pictures around the IP camera itself (S110).

After taking pictures, IP camera (200) encrypts the video data photographed based on encryption key stored in electrically connected hardware security module (S120).

At this time, IP camera (200) encrypts the raw images of the photographed video data by using encryption key stored in hardware security module in the process of compressing the raw images with predetermined specific units of encoding or compressing levels (for example, one unit of a block, a macroblock, a slice, a field, a frame, a picture, an I-frame, a GOP, sequence), or IP camera (200) encrypts the raw images of the photographed video data by using encryption key stored in hardware security module in the process of packetizing the encoded data after compressing the raw images with predetermined specific units of encoding or compressing levels, or IP camera (200) encrypts the the raw images of the photographed video data in both processes described above.

The processor in accordance with the present invention can be configured to perform encryption based on encryption key in hardware security module in the process of compressing the raw image of the photographed video data with the predetermined units, in the process of packetizing the encoded data after compressing the raw image of the photographed video data with the predetermined units of encoding or compressing levels, or in the processes of both compressing the raw image of the photographed video data with the predetermined units and packetizing the encoded data after compressing the raw image of the photographed video data with the predetermined units of encoding or compressing levels.

Moreover, when encrypting the photographed video data through S120, IP camera (200) can encrypt audio data and detected data measured in sensors prepared in IP camera along with the photographed video data.

After encrypting the photographed video data by using encryption key stored in hardware security module through S120, IP camera (200) transmits the encrypted video data to NVR (500) via wired and wireless network (100) (S130). At this time, according to usage environments of a CCTV system, IP camera can directly provide the encrypted video data to user terminal (400) administrated by a security manager.

Then NVR (500) identifies the encrypted video data transmitted from IP camera (200) through S130 by using encryption key stored in NVR (500), and stores/manages the encrypted video data by individual IP camera (200) (S140).

Then NVR (500) transmits the encrypted video data photographed from a specific IP camera (200), which are stored/managed in NVR (500), to user terminal (400) via wired/wireless network (100) (S150).

The user terminal (400) that receives the encrypted video data from NVR (500) through S150 decrypts/plays the encrypted video data by using encryption key stored in the hardware security module electrically connected to user terminal (400) (S160).

At this time, if encryption key of user terminal (400) is not the same as that used for encrypting the video data photographed in IP camera, user terminal (400) cannot decrypt the encrypted video data provided from NVR (500).

The managing server (300) then determines if the time to change encryption key stored in hardware security module equipped/prepared in each IP camera (200), user terminal (400) and NVR (500) in the processes of operating CCTV services through S110 to S160 is coming (S170).

If the time to change encryption key is determined to come as a result of decision of S170, managing server (300) removes all encryption keys in hardware security modules prepared in each IP camera (200), user terminal (400) and NVR (500), updates encryption keys with newly created encryption keys, and then repeats the next steps from S110 (S180).

Moreover, even not shown in figures, in the case that authentication key for securing communication channels are stored in addition to encryption key in hardware security module, IP camera (200) can additionally verify safety for communication channels with NVR (500) through authentication key before transmitting the encrypted video data to NVR (500) through S130. At the same time, NVR (500) can verify safety for the communication channels with user terminal (400) through S150 before transmitting the encrypted video data to user terminal (400). That is, it is possible to prevent the photographed video data from being leaked to unauthorized devices by authenticating IP camera (200), user terminal (400) and NVR (500) before the encrypted video data are actually transmitted/received. Wherein, authentication key can be periodically discarded and created in managing server (300) similarly to the case of encryption key.

As described above, the present invention takes advantages of transmitting encrypted video data which are photographed in IP camera and encrypted through hardware security module, storing and managing encrypted video data in NVR, finally decrypting and playing by a user the photographed video data based on encryption key provided from a managing server, and thus not being easy to decrypt the photographed video data due to encryption even if the photographed video data are leaked.

In addition, the present invention takes advantages of being easy to confirm which point of encrypted video data is encrypted and thus easy to manage the photographed video data.

In addition, the present invention takes advantages of enhancing security key management and security because managing server periodically generates and discards encryption key used in hardware security module. And the present invention takes advantages of preventing the video data from being leaked to unauthorized devices because the communication channels among IP camera, managing server, and user terminal are securely constructed with authentication key.

Moreover, the present invention takes advantages of easily managing encryption associated with CCTV operations, because audio data and sensing data associated with surrounding environment of IP camera along with the raw image can be transmitted to managing server while encrypting the data by using hardware security module of IP camera.

The present invention has been described with reference to an embodiment shown in the figures, which is an exemplification only and the various and equivalent embodiments are made possible by those who have ordinary knowledge in the area the present invention belongs to. Therefore, the technical scope of the present invention will be determined by the claims as follows.

What is claimed is:

1. An apparatus of enhancing security of CCTV, comprising:
a hardware security module configured to produce encrypted video data after encrypting input video data by using an encryption key based on a hardware; and
a processor configured to encode video data acquired from a camera and packetize the encoded video data;
wherein the encryption is configured to be performed in the process of encoding the input video data acquired from a camera, packetizing the encoded video data, or both encoding the input video data and packetizing the encoded video data, and
the processor is configured to encode or packetize the encrypted video data by making the hardware security module encrypt the video data generated in the process of the encoding, packetizing or the combinations thereof.

2. The apparatus of claim 1,
wherein the hardware security module, further comprises:
a secure memory including SD (Secure Digital) memory card storing the encryption key.

3. The apparatus of claim 1,
wherein the apparatus is further configured to provide the encrypted video data to an NVR or a user terminal,
the NVR or the user terminal decrypts and plays the encrypted video data through the hardware security module equipped in the NVR or the user terminal.

4. The apparatus of claim 1,
wherein the processor is further configured to control recording the information indicating which part of the video data is encrypted, in the header of the encrypted video data or a specific individual file as a metadata.

5. The apparatus of claim 1,
wherein the encryption key stored in the hardware security module is periodically generated and discarded through the control of a managing server at a predetermined interval of time.

6. The apparatus of claim 1,
wherein an authentication key for securing communication channels is additionally generated through a managing server and provided to a camera, a user terminal and an NVR, and
the encrypted video data is transmitted and received after encrypting the communication channel using the authentication key.

7. The apparatus of claim 1,
wherein the processor is configured to control encrypting audio data and sensing data measured in senses equipped in the camera, along with the video data acquired from the camera, with the encryption key.

8. The method for enhancing security of CCTV, the method comprises:
producing encrypted video data after encrypting input video data based on hardware by using an encryption key in a hardware security module; and
encoding input video data acquired from a camera and packetizing the encoded video data in a processor,
wherein the encryption is configured to be performed in the process of encoding the input video data acquired from a camera, packetizing the encoded video data, or both encoding the input video data and packetizing the encoded video data, and
the processor is configured to encode or packetize the encrypted video data by making the hardware security module encrypt the video data generated in the process of the encoding, packetizing or the combinations thereof.

9. The apparatus of claim 8,
the method further comprises:
playing the recorded video data after decrypting the encrypted video data through the encryption key in a user terminal.

10. The apparatus of claim 8,
wherein the encryption key stored in the hardware security module is periodically generated and discarded through the control of a managing server at a predetermined interval of time.

11. The apparatus of claim 8,
wherein the method further comprises:
generating additionally an authentication key for securing communication channels through a managing server,
providing the authentication key to a camera, a user terminal and an NVR, and authenticating the communication channels through the authentication key.

12. The apparatus of claim 8,
wherein the processor is configured to control encrypting audio data and sensing data measured in senses equipped in the camera, along with the video data acquired from the camera, with the encryption key.
